(19) United States
(12) Patent Application Publication
(10) Pub. No.: US 2018/0176631 A1
(43) Pub. Date: Jun. 21, 2018

(54) METHODS AND SYSTEMS FOR PROVIDING AN INTERACTIVE SECOND SCREEN EXPERIENCE

(71) Applicant: Zach EFRATI, Hoboken, NJ (US)

(72) Inventor: Zach EFRATI, Hoboken, NJ (US)

(21) Appl. No.: 15/844,490

(22) Filed: Dec. 15, 2017

Related U.S. Application Data
(60) Provisional application No. 62/434,834, filed on Dec. 15, 2016.

(51) Int. Cl. H04N 21/43; H04N 21/262; H04N 21/466; G06F 17/30

(52) U.S. Cl. CPC H04N 21/4307; H04N 21/26291; G06F 17/30029; H04N 21/4668; H04N 21/4661

(57) ABSTRACT

Methods and systems for providing an interactive second screen experience. In particular, the methods and systems provide data related to the timing of interest, expected questions and/or areas of interest and expected answers/information in response to that interest.

### CROSS REFERENCE TO RELATED APPLICATIONS

This application claims priority to U.S. Provisional Patent Application No. 62/434,834 entitled “METHODS AND SYSTEMS FOR PROVIDING AN INTERACTIVE SECOND SCREEN EXPERIENCE” filed Dec. 15, 2016. The content of this application is incorporated by referenced herein in its entirety.

### FIELD OF THE INVENTION

The invention relates to methods and systems for providing an interactive second screen experience.

### BACKGROUND OF THE INVENTION

An interactive second screen experience involves the use of a computing device (commonly a mobile device, such as a tablet or smartphone, but also voice-activated devices such as Amazon Echo® and Google Home®) to provide an enhanced viewing experience for content on another device, such as a television, tablet and mobile phones. Such experiences are usually called “second screen” experiences. In particular, the term commonly refers to the use of such devices to provide interactive features during broadcast content, such as a television program. The use of a second screen supports social television and generates an online conversation around the specific content. Additionally, the use of a second screen further engages viewers with the watched content, program and content provider brand. The second screen experience enriches the viewing experience by adding a layer of information to the content of the viewing experience.

Currently, second screen technology has various limitations and is not interactive and able to receive and compile information to provide an immersive interactive second screen experience.

Existing second screen technology systems include: U.S. Pat. No. 9,003,440 to Sindha et al.; US 2013/0268973 to Archibong et al.; US 2012/0331496 to Copertino; US 2014/0067828 to Archibong et al.; and US 2011/0307931 to Shuster.

These known second screen technology systems are deficient in that they cannot decipher information from various sources including, but not limited to, social media information and/or social media streams, crowd-aggregated sources and content providers, and use such information to provide an interactive and immersive second screen experience.

Accordingly, there exists a need to provide an interactive second screen experience, and the invention described below is aimed at providing solutions to address this need, which is not accomplished by the prior art.

### SUMMARY OF THE INVENTION

To improve upon the prior art, it is an object of the invention to provide an interactive second screen experience. An interactive second screen experience involves the use of a computing device (commonly a mobile device, such as a tablet or smartphone but also voice-activated devices and products such as Siri, Amazon Echo® and Google Home®) to provide an enhanced viewing experience for content on another device, such that it provides a “second screen” or “second speaker” experience.

It is another object of the invention to provide an interactive second screen experience that is able to receive and compile social media information. It is another object of the invention to provide an interactive second screen experience that supports Fan websites, such as Wikia.com and other websites. The second screen experience enriches the viewing experience by adding a layer of information to the content of the viewing experience.

It is another object of the invention to decipher information from one or more separate input streams, which is a source of information to which a second screen service provider accesses to gather information regarding a broadcast.

It is another object to access one or more separate input streams such as social media streams and/or social media information. It is an object of the invention to use such information to provide an interactive second screen experience.

It is another object of the invention to use natural language processing and/or text recognition technology to decipher information from the input streams.

It is another object of the invention to compile information from the input streams and to transmit the information to an output unit to provide a second screen experience.

It is another object of the invention to provide user-activated scenarios to provide this information to a second screen. In such scenarios, the user will ask for information by various means, including, but not limited to, typing a question, pushing a button on a companion app, or, asking a question by voice. It's important to note that, these scenarios can be triggered by the user while content is not playing (for example, if user paused or finished viewing).

It is another object of the invention for interactive features to be triggered by the system (the “push” option) or as a result of a user-activated query (the “pull” option) such as a text question or voice query.

These and other objects of the invention are achieved by a method of providing a second screen experience of a broadcast from one or more separate input streams, the method comprising: providing a computer (or a set of computers); and using said computer to access one or more input streams corresponding to a broadcast, wherein said computer includes software executing on said computer configured to: identify one or more markers related to the broadcast in the one or more input streams, wherein the markers are identified by using natural language processing and/or text recognition technology; and/or image analysis, and/or audio analysis, and/or feedback from users of a second screen service, associate a time stamp with each of the one or more markers to create a second screen event; compile information from the one or more separate input streams during the second screen event, and transmit said information to an output unit to provide a second screen experience of the broadcast to one or more users.

In certain embodiments, the one or more input steams correspond to information received from other devices. In certain embodiments, the broadcast includes services such as Hulu, Netflix, Amazon TV Prime, etc.

In certain embodiments, the markers are identified by using image recognition and or audio recognition technology. In certain embodiments, the markers are identified by using these forms in combination with natural language processing and/or text recognition technology. In certain embodiments, the markers are identified by using image recognition and or audio recognition technology and without using natural language processing and/or text recognition technology and/or video/image recognition technology and/or audio recognition technology. In certain embodiments, one or more techniques can be used to identify markers.

In certain embodiments, the one or more input streams are social media streams. In certain embodiments, the one or more input streams is include information collected through fan websites or sites dedicated to TV shows and movies such as IMDB®

In certain embodiments, the social media streams are selected from sources such as Facebook®, Twitter®, YouTube®, Tumblr, Pinterest, Tumbler, Instagram, Reddit, VK, Flickr, Vine. In certain embodiments, the fan websites are on Wikia.com and/or other known fan websites or fan websites platforms.

In certain embodiments, the one or more input streams are video streams, radio streams, or streams received from the Internet.

In certain embodiments, the one or more input streams are selected from a group consisting of social media, an input stream from a movie reviewer, an input stream from a second running of a movie, a volume increase of a movie, and picking up audio signals from viewers in a theater.

In certain embodiments, the one or more markers are selected from a group consisting of stories, posts, messages, actions corresponding to watching a particular piece of media content, “liking” a particular content objective, feedback from a second screen service users and queuing a particular piece of media content for future viewing.

In certain embodiments, the broadcast is selected from a group consisting of a television program, a movie, an on-demand movie, and a sports broadcast. In certain embodiments, a broadcast in an input source upon which the second screen information source provides additional content about the input source.

In certain embodiments, the broadcast is a live broadcast or a taped, saved or pre-recorded broadcast. In certain embodiments, the content or broadcast is continuous and being continuously provided. In certain embodiments, the broadcast is provided via Netflix, Apple TV, Hulu, and/or other types of video inputs.

In certain embodiments, said computer is a cloud-based computer.

In certain embodiments, the information transmitted to the second screen is filtered, such that the most relevant information is sent to the second screen.

In certain embodiments, said filtered information is normalized. In certain embodiments, normalized means filtering information such that the information is directed to the interests of a user or information that can assist the user in understanding the broadcast. Filtering algorithms can take into parameters such as user's viewing history, past interactions with second screen services and history of users with similar preferences and/or viewing history and/or interaction with second screen services.

In certain embodiments, the information includes the answers to questions posed by a user or by multiple users and/or feedback to information previously provided by a second screen service.

In certain embodiments, a user is provided with the most relevant information during a second screen event.

In certain embodiments, the step of compiling information from the one or more separate input streams that relate to the second screen event comprises: parsing said information to identify the most relevant information during the second screen event as well as peaks of interest at the content that is being broadcasted, wherein only the most relevant information is transmitted to the output unit to provide the second screen experience of the broadcast to the one or more users.

In certain embodiments, the step of compiling information involves retrieving information transmitted as responses from users to questions posed by various users.

In certain embodiments, the step of presenting information to second screen service users involves user-activated scenarios. For example, a user can type a question or press a button on a dedicated app, messenger, etc. or use one's voice to ask questions about a video broadcast or television show. In certain embodiments, this information is sent to the input stream and to the output unit.

In certain embodiments, the system includes heuristic learning whereby only the most popular questions are provided in the second screen event. In certain embodiments, the system and method understands the questions and provides the most popular questions and answers to users in the second screen event.

In certain embodiments, said information transmitted to the output unit to provide a second screen experience comprises user questions and answers, topics of interest, areas of interest, keywords, hyperlinks, and links to third party applications and webpages including webstores.

In certain embodiments, said parsing involves using natural language processing and/or text/image/audio recognition technology.

In certain embodiments, said output unit is selected from a group consisting of an external device, app, website or a backend service.

In certain embodiments, the method includes retrieving information from a database.

In certain embodiments, the database includes one or more second screen events provided by producers of the broadcasts whereby questions and answers are provided (as well as additional content) for the one or more second screen events.

In certain embodiments, the active responses to questions from users are filtered and organized, such that the information gleamed from the active responses of the users is transmitted in the second screen event.

Other objects of the invention are achieved by providing a system for providing an interactive second screen experience of a broadcast from one or more separate input streams comprising: a computer; software executing on said computer for accessing one or more input streams corresponding to a broadcast; an identification module on said computer for identifying one or more markers related to the broadcast in the one or more input streams, wherein the markers are identified by using natural language processing and/or text recognition technology and/or video/image analysis recognition, audio analysis recognition; a time-stamp module on said computer for associating a time stamp with each of the one or more markers to create a second screen event; a compilation module on said computer for compiling information from the one or more separate input streams during the second screen event; and a transmission module for transmitting said information to an output unit to provide a second screen experience of the broadcast to one or more users.

In certain embodiments, the one or more input streams are video streams, video broadcast, radio streams, or streams received from the Internet.

In certain embodiments, the compilation module includes processing for user-activated scenarios. In this embodiment, a user can type or press a button on a app, messenger, etc. or use one's voice to ask questions about a video broadcast or television show and this information is processed on the compilation module and is transferred to the output unit to provide a second screen experience of the broadcast to one or more users.

In certain embodiments, said one or more input streams are social media streams.

In certain embodiments, the social media streams are selected from a group consisting of Facebook®, Twitter®, YouTube®, Tumblr, Pinterest, Tumbler, LinkedIn, Instagram, Reddit, VK, Flickr, Vine, WhatsApp, Snapchat and Meetup.

In certain embodiments, the one or more input streams are selected from a group consisting of social media, an input stream from a movie or TV show reviewer, an input stream from a second running of a movie, a volume increase of a movie, and picking up audio signals from viewers in a theater.

In certain embodiments, the one or more markers are selected from a group consisting of stories, posts, messages, forum boards, actions corresponding to watching a particular piece of media content including from other users who watched the same content, “liking” a particular content objective, and queuing a particular piece of media content for future viewing.

In certain embodiments, the broadcast is selected from a group consisting of a television program, a movie, an on-demand movie, and a sports broadcast. In certain embodiments, the broadcast in an input source upon which the second screen information source provides additional content about the input source.

In certain embodiments, the broadcast is a live broadcast or a taped, saved or pre-recorded broadcast. In certain embodiments, the content or broadcast is continuous and being continuously provided. In certain embodiments, the broadcast is provided via Netflix, Apple TV, Hulu, and/or other types of video inputs.

In certain embodiments, said computer is a cloud-based computer.

In certain embodiments, the information transmitted to the second screen is filtered, such that the most relevant information is sent to the second screen, so that a user is provided with the most relevant information during a second screen event.

In certain embodiments, the step of compiling information from the one or more separate input streams that relate to the second screen event comprises: parsing said information to identify the most relevant information during the second screen event, wherein only the most relevant information is transmitted to the output unit to provide the second screen experience of the broadcast to the one or more users.

In certain embodiments, said information transmitted to the output unit to provide a second screen experience comprises user questions, topics of interest, areas of interest, keywords, hyperlinks, and links to third party applications and webpages including web stores.

In certain embodiments, said parsing involves using natural language processing and/or text recognition technology. In certain embodiments, the parsing involves image recognition and or audio recognition technology.

In certain embodiments, said output unit is selected from a group consisting of an external device, app, website or a backend service.

In certain embodiments, the system learns from feedback given by other second-screen users.

Other objects of the invention are achieved by providing a non-transitory computer readable storage medium storing a program executed by a computer an interactive second screen experience, the non-transitory computer readable storage medium comprising instructions for: identifying one or more markers related to the broadcast in the one or more input streams, wherein the markers are identified by using natural language processing and/or text recognition technology; associating a time stamp with each of the one or more markers to create a second screen event; compiling information from the one or more separate input streams during the second screen event; and transmitting said information to an output unit to provide a second screen experience of the broadcast to one or more users.

In certain embodiments, said output unit is selected from a group consisting of an external device, app, website or a backend service.

In certain embodiments, one or more users can watch the input streams at the original airtime or even at a later time.

In certain embodiments, the broadcast is an input source that is continuously provided Netflix, Apple TV, Hulu, and/or other types of video inputs.

In certain embodiments, the computer described by the system includes a processor and/or computer hardware. In certain embodiments, the computer includes a memory, RAM, and other storage, and computer processing.

In certain embodiments, the computer is replaced by a processor such that the processor is all that is required to execute software and/or software instructions.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic drawing of a system of an embodiment of the invention;

FIG. 2 is a flowchart of an embodiment of a method of the invention; and

### DETAILED DESCRIPTION OF THE INVENTION

In the following description, numerous details are set forth for purpose of explanation. However, one of ordinary skill in the art will realize that the invention may be practiced without the use of these specific details. For instance, the techniques described below are described in a specified order, but other embodiments may change the order of the operations while still embodying the current invention.

An “input stream” is defined as a source of information correlating to a broadcast to which a second screen service provider can access to gather information.

The method and system of the presently claimed invention uses input from streams and/or sources such as social media (but not only, could be rewind of movie, volume increase, picking up audio signals from viewers), and will identify data or information which will help provide a second screen experience.

In particular, the data or information identified may include timing of interest, expected questions and/or areas of interest, and expected answers/information in response to that interest.

In certain embodiments of the invention, the second screen experience could involve receiving information from answering a question from an email, receiving an input such as a rewind of a movie, volume increase, and/or picking up audio signals from viewers. After such an event occurs, the system will understand that an interest or interest event has occurred and will hint the system that something meaningful happened (i.e. a second screen event has occurred).

In certain embodiments, the second screen experience involves analyzing a scene in a broadcast. In certain embodiments, the software can tell if a scene is dramatic by analyzing the scene, such as if a character gasps or is startled, the music suddenly changes, the screen goes black or if multiple cliffhangers or dramatic events occur. In this instance, software on the computer analyzes the scene and determines that a second screen event has occurred.

The system and method is able to anticipate questions in that moment in time and find the answers. For example, if, five minutes into watching a broadcast of an episode of television, the user says “oh my goodness!” and then rewinds several times, it will indicate that something meaningful has happened and that a second screen event has occurred. The system will then know that the second screen event came at that point of the original airtime.

The system will then compile information during that point in time (second screen event) and will transmit the complied information to an output unit to provide a second screen experience of the broadcast to one or more users.

In certain embodiments, the system uses time stamps, natural language processing and other tools to identify information so as to determine when a second screen event occurs.

In certain embodiments, the system corresponds input streams to a broadcasted content by outputting a compilation of information at the second screen event to one or more outputs in real time.

As set forth in this application, the term “Real Time” is defined as input that originated at the same time of watching said broadcast/stream.

As set forth in this application, the term “timestamp” is defined as the elapsed time from the beginning of the show until the said marker is identified, taking into account information which may change the actual timestamp. Information that may change the actual timestamp includes ads, “last-times”, pauses in viewing, etc.

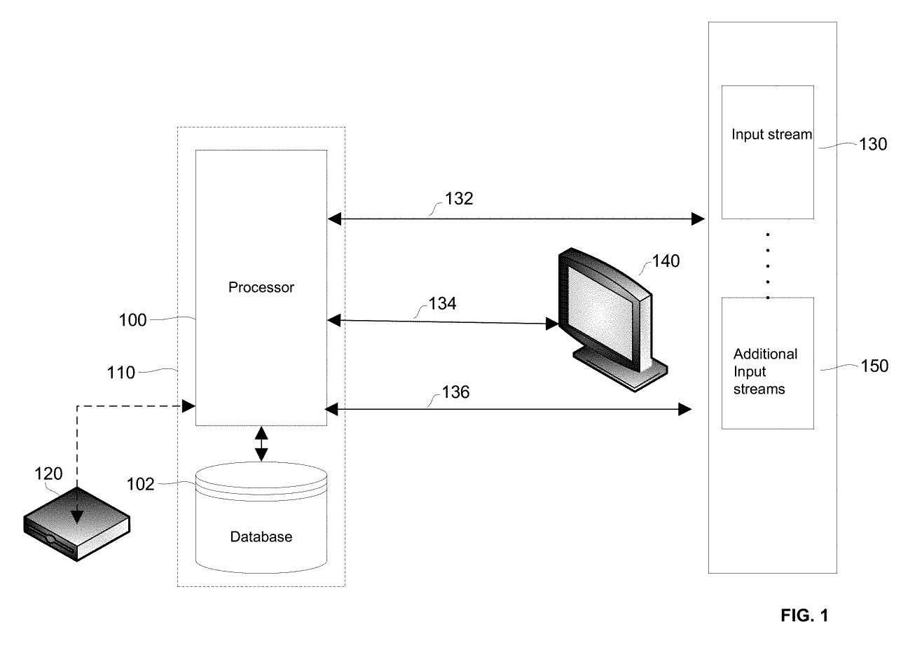

Referring to FIG. 1, a schematic drawing of a system of an embodiment of the invention is provided. In FIG. 1, the system shown includes a computer 110 and software that executes various functionality. The computer includes a processor 100 able to run the software and a memory and non-transient computer readable storage medium able to include instructions for running software.

FIG. 1 also shows a database 102 connected to the processor 100 as well as a display 140 connected to the processor via a link 134. One or more input streams 130 and 150 are accessed by the software executing on the processor 100 via links 132 and 136. These input streams are accessed when the software executing on the server cross references the input streams and performs the method as set forth in various embodiments described in the invention.

In certain embodiments, the links described could be via cables, Bluetooth, Wi-Fi, cable or other technology that allows one device to access a second device.

In certain embodiments, the display 140 is an output unit that provides the second screen experience to one or more users. In certain embodiments, the display 140 could be a computer display, monitor, tablet or smartphone, smartphone app, or any device that is able to display images or pixels such that a user can receive information.

In certain embodiments of the invention, the system is able to use natural language processing to decipher information from the one or more input streams 130, 150. In certain embodiments, multiple and/or a plurality of input streams are available.

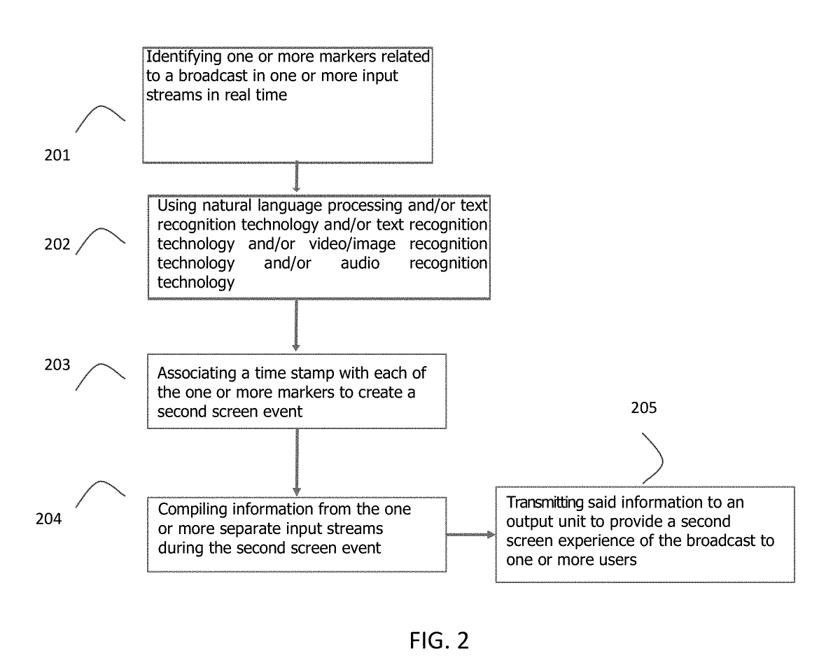

FIG. 2 provides a method for creating a second stream event. FIG. 2 is a flowchart which provides steps for identifying one or more markers related to a broadcast in the one or more input streams in real time (201); using natural language processing and/or text recognition technology and/or text recognition technology and/or video/image recognition technology and/or audio recognition technology (202); associating a time stamp with each of the one or more markers to create a second screen event (203); compiling information from the one or more separate input streams during the second screen event (204); and transmitting said information to an output unit to provide a second screen experience of the broadcast to one or more users (205).

Additional steps possible in the method are set forth in the claims.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A method of providing a second screen experience of a broadcast from one or more separate input streams, the method comprising:
providing a computer; and
using said computer to access one or more input streams corresponding to a broadcast, wherein said computer includes software executing on said computer configured to:
identify one or more markers related to the broadcast in the one or more input streams, wherein the markers are identified by using natural language processing and/or text recognition technology and/or video/image recognition technology and/or audio recognition technology;
associate a time stamp with each of the one or more markers to create a second screen event;
compile information from the one or more separate input streams during second screen event, and
transmit said information to an output unit to provide a second screen experience to one or more users.

2. The method of claim 1, wherein the one or more input streams are social media streams or streams from fan websites or sites dedicated to TV shows and movies.

3. The method of claim 2, wherein the social media streams are selected from sources such as Facebook®, Twitter®, YouTube®, Tumblr, Pinterest, Tumbler, LinkedIn, Instagram, Reddit, VK, Flickr and Vine.

4. The method of claim 1, wherein the one or more input streams are selected from a group consisting of social media, an input stream from a movie reviewer, an input stream from a second running of a movie, a volume increase of a movie, and picking up audio signals from viewers in a theater or in a living room or in a location whereby the broadcast is watched.

5. The method of claim 1, wherein the one or more markers are selected from a group consisting of stories, posts, messages, actions corresponding to watching a particular piece of media content, “liking” a particular content objective, feedback from a second screen service users and queuing a particular piece of media content for future viewing.

6. The method of claim 1, wherein the broadcast is a live broadcast or a taped, saved or pre-recorded broadcast.

7. The method of claim 1, wherein the information transmitted to the second screen is filtered, such that the most relevant information is sent to the second screen.

8. The method of claim 9, wherein a user is provided with the most relevant information during the second screen event.

9. The method of claim 1, wherein the step of compiling information from the one or more separate input streams that relate to the second screen event comprises:
parsing said information to identify the most relevant information during the second screen event as well as peaks of interest at the content that is being broadcasted, wherein only the most relevant information is transmitted to the output unit to provide the second screen experience of the broadcast to the one or more users.

10. The method of claim 10, wherein said information transmitted to the output unit to provide a second screen experience comprises user questions and answers, topics of interest, areas of interest, keywords, hyperlinks, and links to third party applications and webpages including webstores.

11. The method of claim 10, wherein said parsing involves using natural language processing and/or text/image/audio recognition technology.

12. The method of claim 1, wherein said output unit is selected from a group consisting of an external device, app, website or a backend service.

13. A system for providing an interactive second screen experience of a broadcast from one or more separate input streams comprising:
a computer;
software executing on said computer for accessing one or more input streams corresponding to a broadcast;
an identification module on said computer for identifying one or more markers related to the broadcast in the one or more input streams, wherein the markers are identified by using natural language processing and/or text recognition technology and/or video/image recognition technology and/or audio recognition technology;
a time-stamp module on said computer for associating a time stamp with each of the one or more markers to create a second screen event;
a compilation module on said computer for compiling information from the one or more separate input streams during the second screen event; and
a transmission module for transmitting said information to an output unit to provide a second screen experience of the broadcast to one or more users.

14. The system of claim 13, wherein said one or more input streams are social media streams or streams from a fan website, wherein the social media streams are selected from a group consisting of Facebook®, Twitter®, YouTube®, Tumblr, Pinterest, Tumbler, LinkedIn, Instagram, Reddit, VK, Flickr and Vine.

15. The system of claim 13, wherein the one or more input streams are selected from a group consisting of social media, an input stream from a TV or movie reviewer, websites or sites dedicated to TV shows and movies such as IMDB®, an input stream from a second running of a movie, a volume increase of a movie, and picking up audio signals from viewers in a theater or from viewers in a living room.

16. The system of claim 13, wherein the one or more markers are selected from a group consisting of stories, posts, messages, actions corresponding to watching a particular piece of media content including from other users who watched the same content, “liking” a particular content objective, and queuing a particular piece of media content for future viewing.

17. The system of claim 13, wherein the information transmitted to the second screen is filtered, such that the most relevant information is sent to the second screen, so that a user is provided with the most relevant information during a second screen event.

18. The system of claim 13, wherein the step of compiling information from the one or more separate input streams that relate to the second screen event comprises:
parsing said information to identify the most relevant information during the second screen event, wherein only the most relevant information is transmitted to the output unit to provide the second screen experience of the broadcast to the one or more users.

19. The system of claim 18, wherein said information transmitted to the output unit to provide a second screen experience comprises user questions, topics of interest, areas of interest, keywords, hyperlinks, and links to third party applications and webpages including webstores.

20. The system of claim 13, wherein said output unit is selected from a group consisting of an external device, app, website or a backend service.
